(19) United States
(12) Patent Application Publication
(10) Pub. No.: US 2008/0233416 A1
(43) Pub. Date: Sep. 25, 2008

(54) PASTE COMPOSITION, GREEN CERAMIC BODY, AND METHODS FOR MANUFACTURING CERAMIC STRUCTURE

(75) Inventor: Hiroyuki TAKASE, Isaka (JP)

Correspondence Address: BIRCH STEWART KOLASCH & BIRCH, PO BOX 747, FALLS CHURCH, VA, 22040-0747, US

(73) Assignee: KYOCERA Corporation, Kyoto (JP)

(21) Appl. No.: 12/020,305

(22) Filed: Jan. 25, 2008

(30) Foreign Application Priority Data
Jan. 26, 2007 (JP) 2007-016663
Jan. 26, 2007 (JP) 2007-016664

(51) Int. Cl. C03B 29/00; C08G 63/58; B05D 3/02; B32B 27/36

(52) U.S. Cl. 428/480; 524/599; 427/372.2; 156/89.11

(57) ABSTRACT

A paste composition comprises inorganic particles; and a binder containing a copolymer made by copolymerizing a mixture. The mixture comprises a first (meth)acrylic ester whose homopolymer has a first glass transition temperature Tg[h]; and a second (meth)acrylic ester whose homopolymer has a second glass transition temperature Tg[l] lower than the first glass transition temperature Tg[h]. The total molar fraction of the first and second (meth) acrylic esters in the mixture is 80 mol % or more. The first and the second glass transition temperatures Tg[h] and Tg[L] satisfy the relationships Tg[h]≧100° C. and Tg[h]−Tg[l]≧50° C.

### CROSS-REFERENCE TO RELATED APPLICATIONS

The present application claims priority under 35 USC 119(a)-(d) of Japanese Patent Applications No. 2007-016663, filed on Jan. 26, 2007, and No. 2007-016664, filed on Jan. 26, 2007. The contents of these applications are incorporated herein by reference in their entirety.

### BACKGROUND OF THE INVENTION

1. Field of the Invention

The present invention relates to a paste composition containing inorganic particles that are to be sintered by firing, a green ceramic body comprising the paste composition, and a method for manufacturing a ceramic structure.

2. Description of the Related Art

Ceramic structures are used as, for example, ceramic circuit boards on which electronic components, such as LSI's and other semiconductor elements, circuit components, and piezoelectric elements, are mounted. The ceramic circuit board is often manufactured from a paste. For example, a paste containing inorganic insulating particles is formed in a desired shape, such as a sheet to form an insulating layer of a ceramic circuit board, and then fired. A paste containing metal or otherwise conductive inorganic particles may also be applied in a predetermined pattern on the insulating layer and then fired to form a conductor.

Such a paste, if containing electroconductive inorganic particles, can be formed into a fine conductive pattern substantially as designed by screen printing or the like. Thus, the use of a paste allows electronic components, such as multilayer ceramic circuit boards, to be multifunctional, advanced, downsized, and thinly-profiled. The use of a paste also allows to manufacturing a ceramic structure having an intricate shape including, for example, a ceramic structure having many projections or depressions at the surface or inside. Such a paste has begun to be used to make ceramic structures in fields such as a microfluidic device having various flow channels, display components having many depressions and projections on its surface, MEMS's (microelectromechanical systems), and so forth.

A ceramic structure, for example, a multilayer ceramic circuit board including a metalized conductive layer formed on the surface of or inside an insulator defined by a stack of a plurality of insulating layers can be manufactured in the following process. First, a binder, a solvent, and a plasticizer are added to appropriate metal particles and mixed to prepare a metal paste. Then, the metal paste is applied in a predetermined pattern to a ceramic green sheet by a known screen printing technique. A through-hole is formed in the ceramic green sheet with a micro drill or a laser. The through-hole is filled with the metal paste to form a via conductor (may be referred to as via hole), and thus a composite green sheet is prepared.

The composite green sheet and other green sheets are stacked one on top of another. The stack of the green sheets is fired under predetermined conditions. Thus, a multilayer ceramic circuit board having a metalized conductive layer at the surface or inside is produced.

It has been proposed that an acrylic resin is used as the binder of the paste used for such a ceramic structure. This is because acrylic resins can be easily decomposed by heat, and accordingly do not produce carbon or other residues resulting from incomplete firing.

Many trials have been done to improve the binder using an acrylic resin. For example, in Japanese Unexamined Patent Application Publication No. 2006-52368, increasing the molecular weight of the acrylic resin is proposed to get high viscosity and thixotropy of the binder.

Japanese Unexamined Patent Application Publication No. 2002-20570 discloses a technique in which a thixotropic agent is added to a low-molecular-weight acrylic resin. In Japanese Unexamined Patent Application Publication No. 2005-120196, a polar functional group, such as acrylic acid, is introduced. In Japanese Unexamined Patent Application Publication No. 2005-15273, a different type of resin is added to an acrylic resin to control the compatibility.

### BRIEF DESCRIPTION OF THE DRAWINGS

FIG. 1A is a representation of a process for manufacturing a ceramic structure using a paste composition according to an embodiment of the present invention.

FIG. 1B is a representation of a process for manufacturing a ceramic structure using a paste composition according to an embodiment of the present invention.

FIG. 1C is a representation of a process for manufacturing a ceramic structure using a paste composition according to an embodiment of the present invention.

### DESCRIPTION OF THE PREFERRED EMBODIMENTS

A paste composition according to preferred embodiments will now be described in detail.

The paste composition according to the preferred embodiments contains inorganic particles and a binder. The paste composition is fired to remove the binder so that the inorganic particles are sintered. The paste composition can be used, for example, in the manufacture of dielectric ceramic bodies used for electronic components, such as insulators of circuit boards and highly dielectric bodies of capacitors. The paste composition can also be used for forming, for example, metalized coatings used for electronic components, such as conductive layers and via conductors of circuit boards and metal layers for brazing metal members. The paste composition of the present embodiment can be used for forming ceramic bodies and metal bodies of a variety of structures without particular limitation to the manufacture of electronic components.

The inorganic particles used in the paste composition may be made of glass, a metal, a metal oxide, or ceramic. At least two types of inorganic particles may be used in combination. For example, such inorganic particles may be a mixture of different types of inorganic particles, particles of an inorganic material coated with another inorganic material, or an alloy of different metals.

Metal particles used as the inorganic particles in the paste composition include those of Au, Cu, Ag, Pd, W, Mo, Ni, Al, Pt, and their alloys.

Ceramic particles used as the inorganic particles in the paste composition include those of metal oxides, nonmetal oxides, and non-oxides. For example, for a paste composition used for a dielectric body of electronic components such as circuit boards, ceramic particles preferably includes a carbide, nitride, boride or sulfide of an element, such as Li, K, Mg, B, Al, Si, Cu, Ca, Br, Ba, Zn, Cd, Ga, In, a lanthanoid, an actinoid, Ti, Zr, Hf, Bi, V, Nb, Ta, W, Mn, Fe, Co, or Ni.

A complex oxide of at least one of SiO₂, Al₂O₃, ZrO₂ and TiO₂ and an alkaline-earth metal oxide may be used as the ceramic particles. The ceramic particles may be selected according to the application from complex oxides containing at least one oxide selected from the group consisting of ZnO, MgO, MgAl₂O₄, ZnAl₂O₄, MgSiO₃, Mg₂SiO₄, Zn₂SiO₄, Zn₂TiO₄, SrTiO₃, CaTiO₃, MgTiO₃, BaTiO₃, CaMgSi₂O₆, SrAl₂Si₂O₈, BaAl₂Si₂O₈, CaAl₂Si₂O₈, Mg₂Al₄Si₅O₁₈, Zn₂Al₄Si₅O₁₈, AlN, Si₃N₄, SiC, Al₂O₃, and SiO₂ (for example, spinel, mullite, and cordierite).

Glass particles used as the inorganic particles in the paste composition include those of SiO₂—B₂O₃ glass, SiO₂—B₂O₃—Al₂O₃ glass, SiO₂—B₂O₃—Al₂O₃-MO glass, (where M represents Ca, Sr, Mg, Ba, or Zn), SiO₂—Al₂O₃-M¹O-M²O glass (where M¹ and M² may be the same or different and are Ca, Sr, Mg, Ba, or Zn), SiO₂—B₂O₃—Al₂O₃-M¹O-M²O glass (where M¹ and M² are the same as above), SiO₂—B₂O₃-M³₂O glass (where M³ represents Li, Na, or K), SiO₂—B₂O₃—Al₂O₃-M₂O glass (where M³ is the same as above), Pb glass, and Bi glass. A glass containing at least one selected from the group consisting of alkali metal oxides, alkaline-earth metal oxides, and rare earth oxides may be used. The glass used herein may be a material that will be turned amorphous by being fired. Also, the glass may be a crystallizing glass from which a crystal, such as lithium silicate, quartz, cristobalite, cordierite, mullite, anorthite, celsian, spinel, gahnite, willemite, dolomite, or petalite is separated out by firing, or may be a crystallizing glass from which a substituted derivative of those crystals is separated out.

A mixture of ceramic particles and glass particles may be used as the inorganic particles in the paste composition. In this instance, the proportion of the ceramic particles and the glass particles can be appropriately adjusted according to the application. For example, if the paste composition is used for a dielectric body of an electronic component, the weight ratio of ceramic particles to glass particles is preferably in the range of 60:40 to 1:99.

The inorganic particles may contain a sintering agent, such as B₂O₃, ZnO, MnO₂, an alkali metal oxide, an alkaline-earth metal oxide, or a rare earth metal oxide. The sintering agent can be selected from these materials according to the application.

The inorganic particles can be selected according to the application of the sintered body made by firing the paste composition. For example, for an electronic component such as a piezoelectric element, crystals having the perovskite structure, such as barium titanate or lead zirconate-lead titanate solid solution, can be used as the inorganic particles. Exemplary perovskite structures include zirconate titanates, such as lead zirconate titanate (PZT) and lead lanthanum zirconate titanate (PLZT), and lead titanate.

Preferably, the inorganic particles of the paste composition of the present embodiment contain glass particles containing silica. Consequently, the polar functional group of the binder made of an (meth)acrylic ester is adsorbed to the glass particles with a hydrogen bond, and thus the viscosity of the paste composition is increased.

Preferably, the paste composition contains 5 to 150 percent by weight of silica-containing glass particles relative to the solid content of the binder, from the viewpoint of increasing the viscosity or the thixotropy of the paste composition. More preferably, 50 to 120 percent by weight of silica-containing glass particles are contained relative to the solid content of the binder from the viewpoint of stably increasing the viscosity and the thixotropy of the paste composition.

The silica particles contained in the paste composition may be crystalline silica, fused silica, spherical silica, or fumed silica. The silica particles are preferably prepared by a known dry process from the viewpoint of increasing the viscosity or the thixotropy.

Exemplary silica particles prepared by a dry process may be prepared by thermally decomposing silicon tetrachloride at a high temperature of about 1000° C. in the presence of hydrogen and oxygen. As silica particles prepared by a dry process, mesoporous silica may be used, and the mesoporous silica may contain aluminum, titanium, vanadium, boron, manganese, or the like. In general, silica particles prepared by a dry process have a large number of silanol groups at the surfaces of the particles. Accordingly, an adsorbed water molecule layer of chemisorbed water or physisorbed water is formed at the surfaces of the particles. Since the surfaces of the silica particles are thus hydrophilic, the rheological characteristics of the paste composition, such as thixotropy, can be set as desired by adjusting the balance of the binder between the hydrophilic and hydrophobic characteristics.

The particle size of the silica particles is also a factor in determining the rheological characteristics of the paste composition. As the silica particles have a smaller mean primary particle size, the interparticle cohesion is increased and, thus, the viscosity and/or the thixotropy of the paste composition can be increased effectively. In particular, ultrafine silica particles (having a mean primary particle size of about 5 to 100 nm) prepared by a dry process can increase the viscosity and the thixotropy effectively even if the silica particle content is low. By this reason, ultrafine silica particles are preferably used in combination with silica particles having a particle size on the order of microns used in normal glass materials. Preferably, 0.5 to 5 percent by weight of ultrafine silica particles is used relative to the solid content of the binder from the viewpoint of increasing the viscosity and the thixotropy of the paste composition. More preferably, 1 to 3 percent by weight of ultrafine silica particles is used relative to the solid content of the binder from the viewpoint of stably increasing the viscosity and the thixotropy of the paste composition.

The hydroxy group at the surfaces of the silica-containing glass particles may be modified by a reaction with a coupling agent or the like to control the balance between the hydrophilic and hydrophobic characteristics at the surfaces of the silica-containing glass particles. A reactive functional group may be bonded to the surface of the glass particles to form a chemical bond between the binder and the reactive functional group, thereby changing the wettability or the chemical binding properties to the binder at the surface of the silica-containing glass particles.

In general, a combination of a nonpolar binder with hydrophilic glass particles or a combination of a polar binder with hydrophobic glass particles is effective in increasing the thixotropy. The use of silica-containing glass particles allows the surface state of the glass particles to be appropriately changed with a coupling agent according to the polarity of the binder, and thus allows the thixotropy of the paste composition to be controlled finely.

For preparing the paste composition of the present embodiment, it is preferable that the affinity between the below-described solvent used for the paste composition and the inorganic particles or between the additives and inorganic particles be taken into account. In addition, the coupling agent applied to the surfaces of the silica-containing glass particles can help the resulting paste composition exhibit desired rheological characteristics if the coupling agent is appropriately selected or combined.

If the inorganic particles are made of a metal, such as copper, a coupling agent is preferably added to the paste composition. The coupling agent reduces the probability that the metal comes into contact with oxygen, thus minimizing the oxidization of the metal.

The coupling agent can be selected from among silane coupling agents, titanium coupling agents, zirconia coupling agents, and aluminum coupling agents. These coupling agents may be used singly or in combination.

Exemplary silane coupling agents include vinylmethoxysilane, vinylethoxysilane, vinyltrichlorosilane, chloropropyltrimethoxysilane, aminopropyltrimethoxysilane, aminopropyltriethoxysilane, N-(aminoethyl)aminopropyltrimethoxysilane, N-(aminoethyl)aminopropylmethyldimethoxysilane, glycidoxypropyltrimethoxysilane, glycidoxypropylmethyldiethoxysilane, glycidoxypropyltriethoxysilane, p-styryltrimethoxysilane, (3,4-epoxycyclohexyl)ethyltrimethoxysilane, methacryloxypropyltrimethoxysilane, methacryloxypropylmethyldimethoxysilane, methacryloxypropylmethyldiethoxysilane, methacryloxypropyltriethoxysilane, acryloxypropyltrimethoxysilane, mercaptopropyltrimethoxysilane, mercaptopropyl methyldimethoxysilane, bis(triethoxysilylpropyl)tetrasulfide, isocyanatepropyltriethoxysilane, tetramethoxysilane, tetraethoxysilane, methyltrimethoxysilane, methyltriethoxysilane, dimethyltriethoxysilane, phenyltriethoxysilane, hexamethyldisilazane, hexyltrimethoxysilane, and decyltrimethoxysilane.

Exemplary titanium coupling agents include tetraisopropyl titanate, isopropyltriisostearoyl titanate, isopropyltrioctanoyl titanate, isopropyldimethacrylisostearoyl titanate, isopropylisostearoyldiacryl titanate, isopropyltris(dioctylpyrophosphate) titanate, tetra-n-butyl titanate, butyl titanate dimer, tetra(2-ethylhexyl)titanate, tetramethyl titanate, titanium acetylacetonate, titanium tetraacetylacetonate, titanium ethylacetoacetate, titanium octane dioleate, tetraoctylbis(ditridecylphosphite) titanate, tetra(2,2-diallyloxymethyl-1-butyl)bis(ditridecyl)phosphite titanate, bis(dioctylpyrophosphate)oxyacetate titanate, bis(dioctylpyrophosphate)ethylene titanate, titanium lactate, titanium triethanolaminate, and polyhydroxytitanium stearate.

Exemplary zirconium coupling agents include zirconium n-propylate, zirconium n-butylate, zirconium monoacetylacetonate, zirconium bisacetylacetonate, zirconium tetraacetylacetonate, zirconium monoethylacetoacetate, zirconium acetate, zirconium acetylacetonate bisethylacetoacetate, and zirconium monostearate.

Exemplary aluminum coupling agents include aluminum isopropylate, mono-sec-butoxyaluminum diisopropylate, aluminum sec-butylate, aluminum ethylate, ethylacetoacetate aluminum diisopropylate, aluminum tris(ethylacetoacetate), alkylacetoacetate aluminum diisopropylate, aluminum monoacetylacetonate bis(ethylacetoacetate), aluminum tris(acetylacetonate), aluminum monoisopropoxy monooleoxyethylacetoacetate, cyclic aluminum oxide isopropylate, cyclic aluminum oxide octylate, and cyclic aluminum oxide stearate.

These coupling agents may be used singly or in combination. The preferred coupling agent content depends on the type of the coupling agent and the mean particle size or the shape of the silica-containing glass particles.

In order to sufficiently protect the surfaces of the glass particles so as to control the rheological characteristics of the paste composition, the coupling agent content is preferably 0.001 percent by weight or more relative to the solid content of the silica-containing glass particles. In order to further enhance the viscosity stability of the paste composition, it is more preferable that the content of the coupling agent in the paste composition be 5 percent by weight or less. From the economical and practical standpoint, the content of the coupling agent in the paste composition is preferably 0.01 to 3 percent by weight, more preferably 0.05 to 2 percent by weight.

The surfaces of the silica-containing glass particles can be treated with a surface modifier, such as the above-listed coupling agents, under known conditions. For example, a sufficient amount of coupling agent for the surface area of the silica-containing glass particles is dissolved in water or an organic solvent to hydrolyze the coupling agent molecule. Then, the silica-containing glass particles are added to the solution of the coupling agent and stirred. Subsequently, the silica-containing glass particles are separated out of the solution by filtration, centrifugation, or the like. The separated glass particles are heated and dried at a temperature of about 110° C.

A green ceramic base is an article that is changed to a ceramic sintered body by firing. The paste composition of the present embodiment is applied to such a green ceramic base, and thus a green ceramic body is produced. By firing the green ceramic body, the inorganic particles contained in the paste composition and the ceramic sintered body are integrated together to produce a ceramic structure.

The green ceramic base preferably contains the same glass particles as the glass particles used in the paste composition at least at the portion to which the paste composition is applied. Consequently, the green ceramic base and the paste composition are bonded strongly after sintering.

Such a green ceramic base may be a ceramic green sheet used for, for example, a multilayer ceramic circuit board. The inorganic particles of the paste composition are constituted of a mixture of glass particles and electroconductive particles, such as metal particles. The paste composition is applied onto the surface of a ceramic green sheet to produce a ceramic body used for a circuit board. By adding the same glass particles as those contained in the paste composition to the ceramic green sheet, the glass particles in the ceramic green sheet and the glass particles in the paste composition can be favorably integrated together during firing. Thus, the ceramic green sheet and the paste composition can be favorably fired simultaneously. Consequently, the resulting multilayer ceramic circuit board exhibits high adhesion between the layers.

In order to use the paste composition of the present invention for the conductive layers of the circuit board, the glass particle content in the paste composition is preferably 5 parts by weight or less relative to 100 parts by weight of the electroconductive particles. The glass particle content in this range allows the paste composition to have a stable viscosity. Also, the glass particle content in this range does not disturb the electroconductivity of the conductive layer formed by firing.

The binder used in one embodiment of the paste composition of the present embodiment comprises a (meth)acrylic ester copolymer (hereinafter referred to as “copolymer P”) prepared by copolymerizing a mixture of the monomers which comprises an H component and an L component. The H component represents a monomer of a (meth)acrylic ester whose homopolymer has a glass transition temperature Tg[h] of 100° C. or more (Tg[h]≧100° C.). The L component represents a monomer of another (meth)acrylic ester whose homopolymer has a glass transition temperature Tg[l]. In this embodiment, the total molar fraction of the H component and the L component of copolymer P is 80 mol % or more, and the difference ΔTg between the glass transition temperature Tg[h] of the H component and the glass transition temperature Tg[l] of the L component satisfies the relationship ΔTg=(Tg[h]−Tg[l])≧50° C. From economical and rheological consideratitons, the maximum value of the difference ΔTg may be set to be ΔTg≦250° C., preferably ΔTg≦150° C., and more preferably ΔTg≦100° C.

The (meth)acrylic ester represents an acrylic ester or a methacrylic ester. Examples of the (meth)acrylic ester copolymer include copolymers of acrylic esters, copolymers of methacrylic esters, and copolymers of an acrylic ester and a methacrylic ester.

(Meth)acrylic esters that can act as the H component (homopolymer glass transition temperature: Tg[h]≧100° C.) include the following acrylates and methacrylates. Such acrylates include adamantyl acrylate (Tg[h]=153° C.), dimethyladamantyl acrylate (Tg[h]=106° C.), biphenyl acrylate (Tg[h]=110° C.), cyanobutyl acrylate (Tg[h]=111 to 123° C.), cyanoheptyl acrylate (Tg[h]=116° C.), and cyanomethyl acrylate (Tg[h]=160° C.). Such methacrylates include methyl methacrylate (Tg[h]=105° C.), acrylonitrile methacrylate (Tg[h]=110° C.), adamantyl methacrylate (Tg[h]=141° C.), dimethyladamantyl methacrylate (Tg[h]=196° C.), tert-butyl methacrylate (Tg[h]=118° C.), cyanomethylphenyl methacrylate (Tg[h]=128° C.), cyanophenyl methacrylate (Tg[h]=155° C.), dimethylbutyl methacrylate (Tg[h]=108° C.), isobonyl methacrylate (Tg[h]=110° C.), methoxycarbonylphenyl methacrylate (Tg[h]=106° C.), phenyl methacrylate (Tg[h]=110° C.), trimethylcyclohexyl methacrylate (Tg[h]=125° C.), and xylenyl methacrylate (Tg[h]=125 to 167° C.). From the viewpoint of the thermal decomposition characteristics, methacrylates are preferable to acrylates. Methyl L methacrylate is particularly preferable in view of cost.

The (meth)acrylic ester acting as the L component (homopolymer glass transition temperature: Tg[l]) can be arbitrarily selected from the (meth)acrylic esters listed for the H component, as long as the following relationship holds: ΔTg=(Tg[h]−Tg[l])≧50° C. Methacrylates are also preferable to acrylates for the use as the L component from the viewpoint of the thermal decomposition characteristics. Butyl methacrylate (Tg[l]=20° C.) and isobutyl methacrylate (Tg[h]=53° C.), which are general methacrylates, are particularly preferable in view of cost.

The total molar fraction of the H and L components is set to at least 80 mol % relative to the mixture of the monomers. More specifically, the proportions of the H and L components in monomers are set so as to satisfy the relationship (Hm+Lm)/Pm≧0.8, where Pm represents the total moles of the monomers constituting copolymer P, Hm represents the moles of the H component monomer, and Lm represents the moles of the L component monomer. And preferably, either of the H component or the L component is set at least 24 mole relative to the mixture of the monomers.

In this instance, the proportions of the H component and the L component are not particularly limited, and are appropriately set according to the desired rheological characteristics of the paste composition. For example, if the H component content is higher than the L component content, the elasticity can be predominantly controlled among the rheological characteristics of the resulting paste composition. In contrast, if the L component content is higher, the viscosity can be predominantly controlled. From the viewpoint of the balance between the viscosity and the elasticity, (meth)acrylic ester copolymer P used in the paste composition of the present embodiment preferably satisfies the following relationship of the Hm/Lm molar ratio: 3/7≦Hm/Lm≦7/3, and more preferably 4/6≦Hm/Lm≦6/4.

In order to enhance the ease of thermal decomposition or the long-term viscosity stability of the paste composition, and further in order to achieve a high viscosity and a high thixotropy, the mixture of the monomers for (meth)acrylic ester copolymer P of the paste composition preferably further comprises at least one (meth)acrylic ester having a polar functionality, selected from the group consisting of (meth)acrylic esters having hydroxyl group and (meth)acrylic esters having polyalkylene oxide chain. More preferably, the proportion of (meth)acrylic esters having the polar functional group is set at 20 mol % or less relative to the total moles Pm of the monomers constituting copolymer P.

Examples of the (meth)acrylic esters having hydroxyl group include hydroxyethyl acrylate, hydroxyethyl methacrylate, hydroxybutyl acrylate, hydroxybutyl methacrylate, hydroxypropyl acrylate, hydroxypropyl methacrylate, dihydroxyethyl acrylate, dihydroxyethyl methacrylate, dihydroxypropyl acrylate, dihydroxypropyl methacrylate, dihydroxybutyl acrylate, dihydroxybutyl methacrylate, diethylene glycol monoacrylate, diethylene glycol monomethacrylate, glycerol monoacrylate, and glycerol monomethacrylate.

Examples of the (meth)acrylic esters having polyalkylene oxide chain include polymethylene oxide monoacrylate, polymethylene oxide monomethacrylate, polyethylene oxide monoacrylate, polyethylene oxide monomethacrylate, polypropylene oxide monoacrylate, and polypropylene oxide monomethacrylate. The (meth)acrylic esters have a hydroxy group, or an alkoxy group modified with an alkyl group, such as methyl or ethyl, at an end of the molecule are preferable.

Preferably, the binder contained in the paste composition of the present embodiment has a weight-average molecular weight of 20,000 to 100,000 in order to ensure a high viscosity and a high thixotropy or spinnability suitable for screen printing. The weight-average molecular weight can be measured by gel permeation chromatography method using a refractive index detector. A poly-styrene is used as a standard sample of molecular weight in measurement.

The mixture of the monomers for (meth)acrylic ester copolymer P of the paste composition further may comprise another polymerizable monomer as long as the rheological characteristics or the ease of thermal decomposition of the desired paste composition are not degraded. Examples of such a polymerizable monomer include carboxylic acid-containing monomers, glycidyl group-having monomers, amino group- or amido group-having monomers, acrylonitrile, styrene, α-methylstyrene, ethylene, vinyl acetate, and n-vinylpyrrolidone. Exemplary carboxylic acid-containing monomers include acrylic acid, methacrylic acid, maleic acid, itaconic acid, and fumaric acid. Exemplary glycidyl group-having monomers include glycidyl acrylate and glycidyl methacrylate. Exemplary amino or amido group-having monomers include dimethylaminoethyl acrylate, dimethylaminoethyl methacrylate, diethylaminoethyl acrylate, diethylaminoethyl methacrylate, N-tert-butylaminoethyl acrylate, N-tert-butylaminoethyl methacrylate, acrylamide, cyclohexylacrylamide, cyclohexylmethacrylamide, N-methylolacrylamide, and diacetone acrylamide.

(Meth)acrylic ester copolymer P can be produced by a known technique, such as solution polymerization, suspension polymerization, or emulsion polymerization. Since solution polymerization is performed in a solvent, the polymerization product is produced in a binder solution through the polymerization. Suspension polymerization is performed in water and the resulting resin beads are dissolved in a desired solvent to prepare a binder solution. In emulsion polymerization, a monomer is emulsified in water to prepare a micelle, and the emulsified resin is separated out by precipitation or by removing water with a spray dryer. The resulting resin is dissolved in a desired solvent, and thus a binder solution is prepared. From the viewpoint of ease of handling, solution polymerization is preferable.

The paste composition of the present embodiment may further contain a small amount of nitrocellulose to improve the rheological characteristics so as to have a high viscosity and thixotropy suitable for, for example, screen printing. In order to enhance the rheological characteristics as well as maintaining the fluidity of the paste composition, 0.1 to 10 parts by weight of the nitrocellulose relative to 100 parts by weight of the binder may be added to the paste composition, which is preferable when applying the paste composition in a fine pitch to form a conductive layer having a fine pitch. It is preferable that 0.1 to 5 parts by weight of nitrocellulose to 100 parts by weight of the binder be added to the paste composition in case that the applied paste composition is planarized.

In general, nitrocellulose is produced by esterifying the hydroxy group of natural cellulose with nitric acid, and the solubility or viscosity of nitrocellulose in a solvent depends on the substitution degree (nitrification degree) or the polymerization degree. It is accordingly preferable that the nitrocellulose be selected according to the solvent to be used.

Since the binder and additives used in the paste composition can easily be decomposed by heat, as described above, 99 percent by weight or more of them can be decomposed at 500° C. even in a nitrogen atmosphere. Consequently, carbon and other residues in the product are reduced and, thus, problems such as degradation of electroconductivity and mechanical strength become smaller.

Preferred solvents of the paste composition include solvents having high boiling temperatures, such as terpineol, dihydroterpineol, ethyl Carbitol, butyl Carbitol, Carbitol acetate, butyl Carbitol acetate, diisopropyl ketone, methyl cellosolve acetate, cellosolve acetate, butyl cellosolve, butyl cellosolve acetate, cyclohexanone, cyclohexanol, isophorone, dipropylene glycol, propylene glycol monomethyl ether, propylene glycol monomethyl ether acetate, butyl Carbitol methyl-3-hydroxy hexanoate, trimethylpentanediol monoisobutyrate, pine oil, and mineral spirits. It is important to select the solvent. The rheological characteristics of the paste composition depend on the affinity, or compatibility, of the solvent with the binder. As the difference in SP value (solubility parameter) between the binder and the solvent is increased, the viscosity or the thixotropy is generally increased more effectively. A binder having a high solubility in the solvent is easy to handle and allows the resulting paste composition to keep the stability of the viscosity.

The paste composition of the present embodiment may contain a plasticizer or a lubricant. Examples of the plasticizer or lubricant include phthalic acid esters, aliphatic esters, ethylene glycol, propylene glycol, glycerol, and their derivatives. Exemplary phthalic acid ester-based plasticizers or lubricants include dimethyl phthalate, dibutyl phthalate, di-2-ethylhexyl phthalate, diheptyl phthalate, di-n-octyl phthalate, diisononyl phthalate, diisodecyl phthalate, butylbenzyl phthalate, ethylphthalylethyl glycolate, and butylphthalylbutyl glycolate. Exemplary aliphatic ester-based plasticizers or lubricants include di-2-ethylhexyl adipate and dibutyl diglycol adipate. Exemplary ethylene glycol-based plasticizers or lubricants include diethylene glycol, triethylene glycol, polyethylene glycol, diethylene glycol methyl ether, triethylene glycol methyl ether, diethylene glycol ethyl ether, diethylene glycol n-butyl ether, triethylene glycol n-butyl ether, ethylene glycol phenyl ether, ethylene glycol acetate, diethylene glycol monohexyl ether, and diethylene glycol monovinyl ether. Exemplary propylene glycol-based plasticizers or lubricants include dipropylene glycol, tripropylene glycol, polypropylene glycol, dipropylene glycol methyl ether, tripropylene glycol methyl ether, dipropylene glycol monoethyl ether, dipropylene glycol n-butyl ether, tripropylene glycol n-butyl ether, propylene glycol phenyl ether, ethylene glycol benzyl ether, and ethylene glycol isoamyl ether. Exemplary glycerol-based plasticizers or lubricants include glycerol, diglycerol, and polyglycerol.

The paste composition of the present embodiment may contain a dispersant. The dispersant may be, for example, a nonionic surfactant, a cationic surfactant, an anionic surfactant, an amphoteric surfactant, or a polymer emulsifying dispersant.

Exemplary nonionic surfactants include polyoxyethylene glycol, polyoxypropylene glycol, polyoxyethylene alkyl ethers, polyoxyethylene alkylphenyl ethers, glycerol fatty acid partial esters, sorbitan fatty acid partial esters, pentaerythritol fatty acid partial esters, polyoxyethylene sorbitan fatty acid partial esters, polyoxyethylene alkyl ether carboxylates, fatty acid alkanolamides, polyoxyalkylene alkylamines, and alkyldialkylamine oxides.

Exemplary cationic surfactants include alkylamine salts, dialkylamine salts, and quaternary ammonium salts.

Exemplary anionic surfactants include ether carboxylates, dialkyl sulfosuccinates, alkane sulfonates, alkylbenzene sulfonates, alkylnaphthalene sulfonates, polyoxyethylene alkylsulfophenyl ether salts, alkyl phosphates, polyoxyethylene alkyl ether phosphates, fatty acid alkyl ester sulfates, alkyl sulfates, polyoxyethylene alkyl ether sulfates, fatty acid monoglyceride sulfates, and acylated amino acid salts.

Exemplary amphoteric surfactants include betaine amphoteric surfactants and amino acid amphoteric surfactants.

Exemplary polymer emulsifying dispersants include polyvinyl alcohol, starch, starch derivatives, cellulose derivatives, and sodium polyacrylate. The cellulose derivatives include carboxymethyl cellulose, methyl cellulose, and hydroxyethyl cellulose.

Relative to 100 parts by weight of the inorganic particles, 0.5 to 15.0 parts by weight of the binder is preferably added to the paste composition. The organic solvent content is preferably 5 to 100 parts by weight relative to 100 parts by weight of the solid contents including the binder.

The paste composition can be applied in a predetermined pattern to a ceramic green sheet by a known printing technique, such as screen printing or gravure printing. An appropriate adhesive containing a binder, a solvent, and a plasticizer is applied or transferred to the ceramic green sheet having the printed pattern. Then, another ceramic green sheet is stacked on the printed ceramic green sheet and the stack is pressed to be integrated. Thus, a green ceramic body including the stack of the ceramic green sheets having a predetermined pattern of the paste composition is prepared. The resulting ceramic body is fired under predetermined conditions, and, thus, a ceramic structure is produced.

The composition and content of the binder in the paste composition can be analyzed by, for example, GC-Mass spectroscopy or NMR. The Tg[h] and Tg[l] can be obtained by measuring homopolymers produced by polymerizing the respective raw material monomers by, for example, DSC. The glass transition temperature Tg of the resulting copolymer binder can be measured by DSC, or calculated from the Fox equation: 1/Tg=w1/Tg1+w2/Tg2 (where w1 and Tg1 and w2 and Tg2 represent the weight fractions and the glass transition temperatures of each homopolymers).

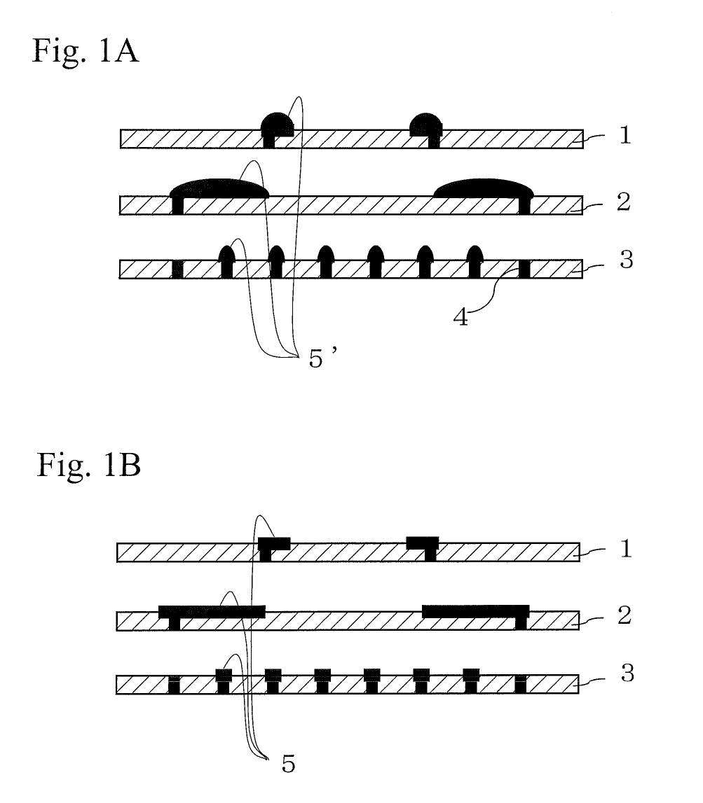

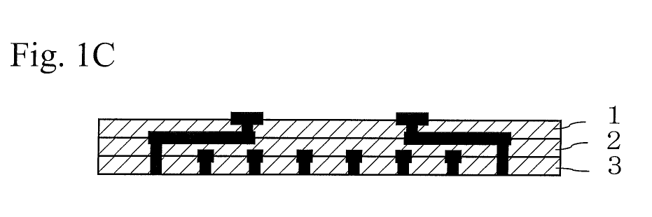

A ceramic circuit board to which the paste composition of the embodiment is applied will now be described in detail with reference to FIGS. 1A, 1B, and 1C.

First, ceramic green sheets 1 to 3 for the ceramic circuit board are prepared as follows. Ceramic particles as a sintering agent are added, if necessary, to the raw material particles of the ceramic green sheets 1 to 3. The raw material particles of the ceramic green sheets may be ceramic particles or glass particles. Additives, such as a resin binder and a plasticizer, and a solvent are added to the mixture to prepare a slurry. Then, the slurry is formed into the ceramic green sheets 1 to 3 having predetermined thicknesses by well known method such as a doctor blade method, rolling method, or pressing method.

Next, through-holes for forming via conductors connecting vertically disposed conductive layers to each other are formed in the ceramic green sheets 1 to 3 by a well known method such as stamping. A paste layer (intended for a conductive layer) 5′ made of the paste composition is formed on the surface of each of the ceramic green sheets 1 to 3, then filling the through-holes with the paste composition, thereby forming via conductors 4. The paste layer (conductive layer) 5′ and via conductors 4 formed of the paste composition are dried.

As illustrated in FIG. 1B, the paste layer 5′ is plastic-deformed to be planarized by pressing at a pressure. The pressure may be set to about 4.9 MPa at a temperature 30±5° C. higher than the glass transition temperature Tg of acrylic ester copolymer P in the paste composition of the paste layer 5′ (within the temperature range of Tg+30±5° C.). Thus, the paste layer 5′ can be planarized into a flat paste layer 5 by plastic deformation with the small deformation of the ceramic green sheets 1 to 3 around the paste layer. The plastic deformation of the paste layer 5′ depends more on the heating temperature than on the pressing pressure. It is therefore preferable that the temperature for plastic deformation be appropriately set according to the glass transition temperature Tg of the binder. Hence, by pressing the paste layer 5′ within the temperature range of Tg+30±5° C. thus plastically-deforming it, gaps resulting from differences in thickness among the internal conductive layers formed in the stack of the ceramic green sheets 1 to 3 can be prevented. Consequently, adhesion failure between the ceramic green sheets 1 to 3, that is, so-called delamination, and deformation of the stack can be smaller.

From the viewpoint of planarizing the external surface of the stack of the ceramic green sheets 1 to 3 including the internal conductive layers, it is preferable that the thickness t of the flat paste layer 5 planarized by plastic deformation and the thickness T of the ceramic green sheet 1 to 3 in contact with the flat paste layer 5 satisfy the relationship: t≦0.7T.

Then, an adhesive containing a binder, a solvent, and a plasticizer is applied or transferred to the resulting ceramic green sheets 1 to 3.

Finally, as illustrated in FIG. 1C, the ceramic green sheets 1 to 3 are stacked and pressed together to be integrated, thus producing a green ceramic body including the stack of the ceramic green sheets onto which the paste composition is applied in desired patterns. The resulting green ceramic body is fired under predetermined conditions, thus resulting in a ceramic structure.

The ceramic particles, the glass particles, and the sintering agents listed as the inorganic particles of the paste composition can be used as those of the ceramic green sheet.

Examples of the resin binder of the ceramic green sheet include acrylic polymer, polyvinyl acetal polymer, cellulose polymer, polyvinyl alcohol polymer, polyvinyl acetate polymer, polyvinyl chloride polymer, and polypropylene carbonate polymer. These polymers may be homopolymers formed from a single type of monomer or copolymers formed from different types of monomers. The acrylic polymer above includes a polymer of at least one selected from the group consisting of acrylic acid, methacrylic acid, acrylic ester, and methacrylic ester.

Exemplary monomers forming the acrylic polymer include methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, cyclohexyl acrylate, cyclohexyl methacrylate, 2-ethylhexyl acrylate, 2-ethylhexyl methacrylate, isononyl acrylate, isononyl methacrylate, isodecyl acrylate, and isodecyl methacrylate. If a copolymer whose main chain is formed of these acrylic esters or methacrylic esters is used, the copolymer preferably contains a monomer having a carboxyl, alkylene oxide, hydroxy, glycidyl, amino, or amido group as a copolymerization component. The mixture of the monomers for (meth)acrylic ester copolymer P may further comprise another copolymerizable material, such as acrylonitrile, styrene, ethylene, vinyl acetate, or n-vinyl pyrrolidone.

Examples of the carboxyl group-having monomer include acrylic acid, methacrylic acid, maleic acid, itaconic acid, and fumaric acid. Examples of the alkylene oxide-having monomer include methylene oxide, ethylene oxide, and propylene oxide. Examples of the hydroxy group-having monomer include 2-hydroxyethyl acrylate, 2-hydroxyethyl methacrylate, 2-hydroxybutyl acrylate, 2-hydroxybutyl methacrylate, diethylene glycol monoacrylate, diethylene glycol monomethacrylate, glycerol monoacrylate, glycerol monomethacrylate, trimethylolpropane triacrylate, and trimethylolpropane trimethacrylate. Examples of the glycidyl group-having monomer include glycidyl acrylate and glycidyl methacrylate. Examples of the amino or amido group-having monomer include dimethylaminoethyl acrylate, dimethylaminoethyl methacrylate, diethylaminoethyl acrylate, diethylaminoethyl methacrylate, N-tert-butylaminoethyl acrylate, N-tert-butylaminoethyl methacrylate, acrylamide, cyclohexylacrylamide, cyclohexylmethacrylamide, N-methylolacrylamide, and diacetone acrylamide.

Exemplary polyvinyl acetal polymers include polyvinyl butyral, polyvinylethylal, polyvinylpropylal, polyvinyloctylal, polyvinylphenylal, and their derivatives.

Exemplary cellulose polymers include methyl cellulose, ethyl cellulose, carboxymethyl cellulose, hydroxypropyl cellulose, hydroxypropylmethyl cellulose, nitrocellulose, and cellulose acetate.

If electroconductive particles, such as metal particles, are used as the inorganic particles of the paste composition, the paste composition can be used as an electroconductive paste, which can form a conductor by firing. For example, the paste composition is applied in a pattern to a ceramic green sheet to prepare a green ceramic body, and thus the ceramic green sheet and the paste composition are fired together to produce a ceramic structure including an integrated conductor. Alternatively, the paste composition may be applied in a pattern to a ceramic substrate that has already been fired, and then again fired to produce a ceramic structure including an integrated conductor.

If a dielectric material, such as ceramic or glass, is used as the inorganic particles of the paste composition, the paste composition can be used as a dielectric paste, which can form a dielectric body by firing. For example, the paste composition is applied in a desired pattern onto the surface of a ceramic green sheet to prepare a ceramic body and then the ceramic green sheet and the paste composition are fired together to produce a ceramic structure including an integrated desired pattern. Alternatively, the paste composition may be applied in a pattern to a ceramic substrate that has already been fired, and then fired again to produce a ceramic structure including dielectric bodies integrated together. Also, the paste composition may be formed into a sheet that can be used as, for example, a ceramic green sheet.

While the invention has been described using exemplary embodiments, the invention is not limited to the above described embodiments, and various modifications may be made without departing from the spirit and scope of the invention.

### EXAMPLE 1

### 1. Preparing Ceramic Green Sheet

To 100 parts by weight of a Glass-ceramic raw material powder containing SiO₂, Al₂O₃, CaO, ZnO, and B₂O₃ were added 11 parts by weight of an acrylic binder and 5 parts by weight of plasticizer dibutyl phthalate. The materials were mixed with toluene as an organic solvent in a ball mill for 36 hours to prepare a slurry. The resulting slurry was formed into a 300 μm thick ceramic green sheet by a doctor blade method and subsequent drying. The ceramic green sheet was punched to form a through hole of 200 μm diameter therein.

Subsequently, the through hole of the ceramic green sheet was filled with a first paste composition (Samples 1 to 21 of Table 1) by screen printing. The proportions of the binder components shown in Table 1 are on a molar basis.

Then, the following second paste composition was applied in a fine pattern (desired line widths: 55 μm, desired thickness: 16 μm) by screen printing. The pattern made of the second paste composition was dried in a hot air drying oven at 80° C. for 1 hour, thus forming metalized conductive layers.

### 2. Preparing Paste Composition

### 2-1 First Paste Composition (for Forming Via Conductor)

To 100 parts by weight of Cu powder were added 2 parts by weight of the glass-ceramic raw material powder used above for the ceramic green sheet, 2 parts by weight of the binder shown in Samples 1-21 of Table 1, 4 parts by weight of a mixed solvent of terpineol and butyl Carbitol acetate, and 2 parts by weight of dibutyl phthalate, and then the materials were stirred to be mixed. Subsequently, the mixture was further mixed in a three roll mill until the aggregate of the Cu powder and binder disappeared. Thus, the first paste composition was prepared.

In the column of the binder component shown in Table 1, MMA represents methyl methacrylate; BMA, butyl methacrylate; IBMA, isobutyl methacrylate; EMA, ethyl methacrylate; MPEGMA, methoxypolyethylene glycol monomethacrylate; PEGMA, polyethylene glycol monomethacrylate; GLMA, glycerol monomethacrylate; 2HEMA, 2-hydroxyethyl methacrylate; MAA, methacrylic acid; 2EHMA, 2-ethylhexyl methacrylate; 2EHA, 2-ethylhexyl acrylate; and NC, nitrocellulose.

### 2-2 Second Paste Composition (for Conductive Layers

To 100 parts by weight of Cu powder were added 3 parts by weight of the glass-ceramic raw material powder used above for the ceramic green sheet, 4 parts by weight of the binder shown in Samples 1-21 in Table 1 (the same as the binder of the via conductor), 10 parts by weight of a mixed solvent of terpineol and butyl Carbitol acetate, and 2 parts by weight of dibutyl phthalate, and the materials were stirred to be mixed. Subsequently, the mixture was further mixed in a three roll mill until the aggregate of the Cu powder and binder disappeared. Thus, the second paste composition was prepared.

### 3. Preparing Multilayer Ceramic Circuit Board

Three ceramic green sheets prepared as in 1. above, to which an adhesive containing an acrylic resin, a solvent, and a phthalic ester plasticizer had been applied, were stacked and pressed at a pressure of 4.9 MPa to be integrated together. Thus, a ceramic green sheet stack including fine conductive layers inside was prepared. Then, the stack was placed on an Al₂O₃ setter and subjected to the removal of the binder in an atmosphere of a nitrogen-hydrogen-water vapor mixture in a furnace using a predetermined temperature profile, followed by firing at a maximum temperature of 950 to 1000° C.

### COMPARATIVE EXAMPLE 1

Multilayer ceramic circuit boards (Comparative Samples 1 to 13) were prepared in the same manner as those of Samples 1 to 21 except that the binders of Comparative Samples 1 to 13 shown in Table 1 were used as the binder of the first and the second paste compositions.

### Spinnability of the First and the Second Paste Compositions

The binder components of the first and the second paste compositions used in Samples 1 to 21 and Comparative Samples 1 to 13 are shown in Table 1. Table 1 also shows the results of the following measurements, the visual evaluation results (◯: good, Δ: fair, or x: poor) of the spinnability (snap-off characteristics from a printing screen) of the first and the second paste as a screen printing characteristic.

### Line Width of the Conductive Layer

The conductive layers were formed of the second paste composition on a ceramic green sheet by printing and drying (before firing). The line width and thickness of the conductive layers (desired line width: 55 μm, desired thickness: 16 μm) were measured at 10 points for each sample with an ultra-deep profile measuring microscope (VK8510, manufactured by Keyence Corporation) and averaged. In Table 1, the sample in which the line width in the conductive layers was within ±5% from the desired values, was evaluated as ◯ (good). The sample in which the line width was within ±15% from the desired value, however, the line width was not within 5%, was evaluated as Δ (fair). The sample in which the line width was not within ±15% from the desired value, was evaluated as x (poor).

Measuring Binder Residue after Thermal Decomposition

The binder (or binder mixture, if at least two types of binder were used) used was subjected to thermogravimetry/differential thermal analysis (TG/DTA) in a N₂ atmosphere at a heating rate of 10° C./minute up to 500° C. with a high-temperature differential thermobalance (TG8120, manufactured by Rigaku Corporation), and the rate of thermal decomposition residue at 500° C. was calculated from the equation: 100×(residue weight at 500° C.)/(sample weight before analysis).

### Measuring Rheological Characteristics of First and the Second Paste Compositions

The viscosity was measured at 1 s⁻¹ and 100 s⁻¹ by a cone-plate method (using a 1 degree cone of 25 mm in diameter, 25° C.) with a rheometer MCR301 manufactured by Physica. The TI value (thixotropy index, ratio of viscosity at 1 s⁻¹ to viscosity at 100 s⁻¹) was also calculated. The measurement was performed twice, immediately after the preparation of the first and the second paste compositions and after a week, and the rate of viscosity change after a week at viscosities of both 1 s⁻¹ and 100 s⁻¹ were calculated from the equation: 100×{(viscosity after a week)−(viscosity immediately after preparation)}/(viscosity immediately after preparation). Hereinafter, the rate of viscosity change after a week at viscosity of 1 s⁻¹ is referred to “RVC1” and the rate of viscosity change after a week at viscosity of 100 s⁻¹ is referred to “RVC2”. In Table 1, the sample in which both of RVC1 and RVC2 were not less than −30% and not more than 30%, was evaluated as ◯ (good). The sample in which both of RVC1 and RVC2 were not less than −40% and not more than 40%, however, at least one of RVC1 and RVC2 was not less than 30% or not more than −30%, was evaluated as Δ (fair). The sample in which at least one of RVC1 and RVC2 was not less than 40% or not more than −40%, was evaluated as x (poor).

### Total Evaluation

In the total evaluation of the Table 1, [symbol] (excellent) indicates all of “Rate of viscosity change after 1 week”, “Spinnability” and “Line width” were good. ◯ (good) indicates all of “Rate of viscosity change after 1 week”, “Spinnability” and “Line width” were at least fair although not all of them are good. x (poor) indicates at least one of “Rate of viscosity change after 1 week”, “Spinnability” and “Line width” was poor.

TABLE 1

| | Binder | | | | | |
|---|---|---|---|---|---|---|
| | | Molecular | Glass transition | | | 500° C. |
| | Binder component | weight | temperature (° C.)* | | | Residue ratio |
| | (numbers represent proportions) | (×10⁴) | Tg[h] | Tg[l] | ΔTg | (wt %) |
| | Random copolymer | | | | | |
| Sample 1 | [MMA-co-BMA-co-MPEGMA = 47/47/6] + NC = 100/10 | 2.1 | 105 | 20 | 85 | 0.8 |
| Sample 2 | [MMA-co-BMA-co-PEGMA = 47/47/6] + NC = 100/10 | 2.2 | 105 | 20 | 85 | 0.7 |
| Sample 3 | [MMA-co-BMA-co-GLMA = 47/47/6] + NC = 100/10 | 2.4 | 105 | 20 | 85 | 0.7 |
| Sample 4 | [MMA-co-BMA-co-2HEMA = 47/47/6] + NC = 100/10 | 3.2 | 105 | 20 | 85 | 0.8 |
| Sample 5 | [MMA-co-BMA-co-MPEGMA = 47/47/6] + NC = 100/5 | 9.3 | 105 | 20 | 85 | 0.4 |
| Sample 6 | [MMA-co-BMA-co-PEGMA = 47/47/6] + NC = 100/5 | 8.9 | 105 | 20 | 85 | 0.6 |
| Sample 7 | [MMA-co-BMA-co-GLMA = 47/47/6] + NC = 100/5 | 9.6 | 105 | 20 | 85 | 0.5 |
| Sample 8 | [MMA-co-BMA-co-2HEMA = 47/47/6] + NC = 100/5 | 9.2 | 105 | 20 | 85 | 0.4 |
| Sample 9 | [MMA-co-IBMA-co-MPEGMA = 47/47/6] + NC = 100/5 | 8.8 | 105 | 48 | 57 | 0.8 |
| Sample 10 | [MMA-co-IBMA-co-PEGMA = 47/47/6] + NC = 100/5 | 9.4 | 105 | 48 | 57 | 0.5 |
| Sample 11 | [MMA-co-IBMA-co-GLMA = 47/47/6] + NC = 100/5 | 9.3 | 105 | 48 | 57 | 0.6 |
| Sample 12 | [MMA-co-IBMA-co-2HEMA = 47/47/6] + NC = 100/5 | 8.9 | 105 | 48 | 57 | 0.8 |
| Sample 13 | [MMA-co-BMA-co-2HEMA = 40/40/20] + NC = 100/5 | 9.3 | 105 | 20 | 85 | 0.8 |
| Sample 14 | [MMA-co-BMA-co-2HEMA = 67/28/5] + NC = 100/3 | 4.8 | 105 | 20 | 85 | 0.4 |
| Sample 15 | [MMA-co-BMA-co-2HEMA = 24/56/20] + NC = 100/10 | 5.7 | 105 | 20 | 85 | 0.7 |
| Sample 16 | MMA-co-BMA = 50/50 | 32 | 105 | 20 | 85 | 0.3 |
| Sample 17 | MMA-co-BMA-co-MAA = 49/49/2 | 4.8 | 105 | 20 | 85 | 0.8 |
| Sample 18 | MMA-co-BMA-co-2HEMA = 40/40/20 | 9.3 | 105 | 20 | 85 | 0.8 |
| Sample 19 | [MMA-co-BMA = 50/50] + NC = 100/10 | 1.9 | 105 | 20 | 85 | 0.6 |
| Sample 20 | [MMA-co-BMA-co-2HEMA = 47/47/6] + NC = 100/10 | 13 | 105 | 20 | 85 | 0.6 |
| | block copolymer | | | | | |
| Sample 21 | MMA-b-BMA = 50/50 | 28 | 105 | 20 | 85 | 0.6 |
| | Random copolymer | | | | | |
| Comparative | MMA-co-EMA = 50/50 | 32 | 105 | 65 | 40 | 0.6 |
| Sample 1 | | | | | | |
| Comparative | IBMA-co-2EHMA = 50/50 | 33 | 48 | −10 | 58 | 0.3 |
| Sample 2 | | | | | | |
| Comparative | EMA-co-BMA = 50/50 | 31 | 65 | 20 | 45 | 0.4 |
| Sample 3 | | | | | | |
| Comparative | BMA-co-2EHA = 50/50 | 34 | 20 | −68 | 88 | 1.3 |
| Sample 4 | | | | | | |
| Comparative | IBMA-co-BMA = 50/50 | 33 | 48 | 20 | 28 | 0.2 |
| Sample 5 | | | | | | |
| Comparative | IBMA-co-BMA-co-2HEMA = 47/47/6 | 27 | 48 | 20 | 28 | 0.4 |
| Sample 6 | | | | | | |
| Comparative | MMA-co-BMA-co-2HEMA = 35/35/30 | 8.7 | — | — | — | 0.9 |
| Sample 7 | | | | | | |
| Comparative | [MMA-co-EMA-co-2HEMA = 47/47/6] + NC = 100/5 | 2.6 | 105 | 65 | 40 | 0.8 |
| Sample 8 | | | | | | |
| | block copolymer | | | | | |
| Comparative | MMA-b-EMA = 50/50 | 40 | 105 | 65 | 40 | 0.7 |
| Sample 9 | | | | | | |
| | Homopolymer mixture | | | | | |
| Comparative | MMA + BMA = 50/50 | 28 + 36 | 105 | 20 | 85 | 0.4 |
| Sample 10 | | | | | | |
| Comparative | MMA + IBMA = 50/50 | 28 + 34 | 105 | 48 | 57 | 0.2 |
| Sample 11 | | | | | | |
| Comparative | MMA + EMA = 50/50 | 28 + 23 | 105 | 65 | 40 | 0.7 |
| Sample 12 | | | | | | |
| | Homopolymer | | | | | |
| Comparative | BMA | 36 | — | 20 | — | 0.3 |
| Sample 13 | | | | | | |

| | Rheological characteristics | | | | | | | | | |
|---|---|---|---|---|---|---|---|---|---|---|
| | of first and the second | | | | | | | | | |
| | paste compositions | | | | | | | | | |
| | | | | Rate of viscosity | | | | | | |
| | | | | change after | | | | conductive layer | | |
| | | | Tl value | 1 week (%) | | | | dimensions | | |
| | Viscosity (Pa · s) | | (η1s⁻¹/ | | | evalu- | Spinna- | (μm) | | Total |
| | η1s⁻¹ | η100s⁻¹ | η100s⁻¹) | η1s⁻¹ | η100s⁻¹ | ation | bility | Line width | Thickness | evaluation |
| Sample 1 | 345 | 27 | 12.8 | −5 | −18 | ◯ | ◯ | 56 (◯) | 16 | ⊚ |
| Sample 2 | 390 | 39 | 10.1 | −13 | −20 | ◯ | ◯ | 56 (◯) | 15 | ⊚ |
| Sample 3 | 293 | 50 | 5.8 | −9 | −7 | ◯ | ◯ | 57 (◯) | 16 | ⊚ |
| Sample 4 | 386 | 70 | 5.5 | −9 | −9 | ◯ | ◯ | 56 (◯) | 15 | ⊚ |
| Sample 5 | 378 | 38 | 9.9 | −5 | −11 | ◯ | ◯ | 56 (◯) | 17 | ⊚ |
| Sample 6 | 421 | 41 | 10.3 | −11 | −16 | ◯ | ◯ | 56 (◯) | 15 | ⊚ |
| Sample 7 | 336 | 68 | 4.9 | −7 | −7 | ◯ | ◯ | 56 (◯) | 16 | ⊚ |
| Sample 8 | 417 | 95 | 4.4 | −11 | −8 | ◯ | ◯ | 57 (◯) | 17 | ⊚ |
| Sample 9 | 395 | 44 | 9.0 | −9 | −15 | ◯ | ◯ | 56 (◯) | 16 | ⊚ |
| Sample 10 | 436 | 48 | 9.1 | −18 | −23 | ◯ | ◯ | 56 (◯) | 17 | ⊚ |
| Sample 11 | 344 | 75 | 4.6 | −15 | −19 | ◯ | ◯ | 57 (◯) | 16 | ⊚ |
| Sample 12 | 432 | 101 | 4.3 | −22 | −16 | ◯ | ◯ | 56 (◯) | 16 | ⊚ |
| Sample 13 | 421 | 103 | 4.1 | 24 | 14 | ◯ | ◯ | 56 (◯) | 16 | ⊚ |
| Sample 14 | 433 | 119 | 3.6 | 4 | −6 | ◯ | ◯ | 56 (◯) | 16 | ⊚ |
| Sample 15 | 313 | 46 | 6.8 | −11 | −8 | ◯ | ◯ | 57 (◯) | 15 | ⊚ |
| Sample 16 | 313 | 102 | 3.1 | 21 | 18 | ◯ | Δ | 58 (◯) | 14 | ◯ |
| Sample 17 | 466 | 115 | 4.1 | 33 | 25 | □ | ◯ | 56 (◯) | 16 | ◯ |
| Sample 18 | 211 | 114 | 1.9 | 21 | 14 | ◯ | ◯ | 62 (□) | 14 | ◯ |
| Sample 19 | 418 | 42 | 10.0 | −33 | −39 | □ | ◯ | 57 (◯) | 15 | ◯ |
| Sample 20 | 462 | 111 | 4.2 | −13 | −7 | ◯ | Δ | 59 (□) | 14 | ◯ |
| Sample 21 | 221 | 94 | 2.4 | 8 | 5 | ◯ | ◯ | 60 (□) | 14 | ◯ |
| Comparative | X Paste solidified | | | — | — | | — | — | — | X |
| Sample 1 | (measurement and | | | | | | | | | |
| | printing impossible) | | | | | | | | | |
| Comparative | 123 | 101 | 1.2 | −13 | −23 | ◯ | Δ | 86 (X) | 12 | X |
| Sample 2 | | | | | | | | | | |
| Comparative | 129 | 109 | 1.2 | −21 | −14 | ◯ | Δ | 83 (X) | 11 | X |
| Sample 3 | | | | | | | | | | |
| Comparative | 108 | 88 | 1.2 | −10 | −16 | ◯ | Δ | 92 (X) | 10 | X |
| Sample 4 | | | | | | | | | | |
| Comparative | 178 | 111 | 1.6 | 14 | −21 | ◯ | Δ | 78 (X) | 12 | X |
| Sample 5 | | | | | | | | | | |
| Comparative | 193 | 121 | 1.6 | 23 | 31 | □ | X | 76 (X) | 12 | X |
| Sample 6 | | | | | | | | | | |
| Comparative | X Paste solidified | | | — | — | | — | — | — | X |
| Sample 7 | (measurement and | | | | | | | | | |
| | printing impossible | | | | | | | | | |
| Comparative | 501 | 131 | 3.8 | 42 | 46 | X | X | 59 (□) | 19 | X |
| Sample 8 | | | | | | | | | | |
| Comparative | X Paste solidified | | | — | — | | — | — | — | X |
| Sample 9 | (measurement and | | | | | | | | | |
| | printing impossible) | | | | | | | | | |
| Comparative | X Paste solidified | | | — | — | | — | — | — | X |
| Sample 10 | (measurement and | | | | | | | | | |
| | printing impossible) | | | | | | | | | |
| Comparative | X Paste solidified | | | — | — | | — | — | — | X |
| Sample 11 | (measurement and | | | | | | | | | |
| | printing impossible) | | | | | | | | | |
| Comparative | X Paste solidified | | | — | — | | — | — | — | X |
| Sample 12 | (measurement and | | | | | | | | | |
| | printing impossible) | | | | | | | | | |
| Comparative | 123 | 48 | 2.6 | 23 | 21 | ◯ | Δ | 84 (X) | 11 | X |
| Sample 13 | | | | | | | | | | |

*Glass transition temperatures of ternary binders are represented by Tg[h] for H component and Tg[l] for L component, satisfying (Hm + Lm)/Pm ≧ 0.8.
□: excellent,
◯: good,
□: fair,
X: poor

As shown in Table 1, Samples 1 to 21 using the first and the second paste compositions prepared according to the present invention exhibited superior rheological characteristics and suitably low spinnability. Also, the first and the second paste compositions of Samples 1 to 21 had superior printing characteristics and formed favorable printed patterns as desired. In addition, the first and the second paste compositions of Samples 1 to 21 had suitable long-term viscosity stability and were, accordingly, able to be stored for a long time. In particular, the binder compositions of Samples 1 to 15, which contain a (meth)acrylic ester copolymer and nitrocellulose, exhibited superior results on the whole.

Sample 21 used a copolymer constituted of the same monomers and having substantially the same molecular weight as the copolymer used for Sample 16, but formed by block copolymerization unlike the copolymer used for Sample 16 formed by random copolymerization. Comparing Samples 16 and 21, the first and the second paste composition of Sample 21 using the block copolymer exhibited a lower viscosity and a lower thixotropy in spite of its high molecular weight, thus exhibiting spinnability improved from that of Sample 16.

On the other hand, Comparative Samples 1 to 6, which intended to enhance the printing characteristics by increasing the molecular weight of the (meth)acrylic ester copolymer, notably exhibited high spinnability, which is typical of high-molecular-weight acrylic resin, and accordingly the printed conductive layers were undesirably deformed. Comparative sample 1 used an H component satisfying Tg[h]≧100° C., but did not satisfy ΔTg≧50° C. Consequently, the first and the second paste exhibited low fluidity and was gelled, and accordingly it was not able to be applied by printing. Comparative Samples 2 to 5 each used an H component having a glass transition temperature of Tg[h]<100° C., but used an L component selected so that ΔTg would become about 50° C. The resulting paste compositions exhibited a low viscosity and a low thixotropy, and accordingly the resulting printed patterns were, for example, spread and thus unfavorable. In Comparative Sample 6, 2HEMA having a polar functional group was copolymerized. Consequently, the viscosity and the thixotropy of the first and the second paste were improved to some extent, but the spinnability was worsened. In Comparative Sample 7, the molecular weight of the binder was reduced and a polar functional group-having 2HEMA was increased. As a result, the viscosity was gradually increased from a time immediately after the preparation of the first and the second paste composition, and the composition finally gelled after several days to the extent that it was not able to be applied by printing.

The results above suggest that the binder containing (meth)acrylic ester copolymer P containing an H component and an L component in proportions of (Hm+Lm)/Pm<0.8, that is, copolymer P in which more than 20 mol % of a polar functional group-having (meth)acrylic ester is copolymerized, causes excessive intermolecular interaction.

Comparative Sample 8 intended to increase the viscosity and the thixotropy of the paste by using a 2HEMA-containing methacrylate having a low molecular weight in combination with nitrocellulose. However, the resulting paste exhibited a high elasticity and poor spinnability during screen printing, due to ΔTg<50° C. In addition, the viscosity of the paste was increased to a large extent over a week.

Comparative Sample 9 used a copolymer constituted of the same monomers and having the same molecular weight as the copolymer used for Comparative Sample 1, but formed by block copolymerization unlike the copolymer used for Comparative Sample 1 formed by random copolymerization. In comparison between Samples 1 and 9, Comparative Sample 9 did not produce the same effect of reducing the viscosity and thixotropy as Sample 21, and the first and the second paste was gelled.

Comparative Samples 10 to 12 exhibited unstable long-term viscosity and gelled after several days.

Comparative Sample 13 used a high-molecular weight BMA homopolymer. The conductive layers printed with the first and the second paste of Comparative Sample 13 were spread.

### EXAMPLE 2

### 1. Preparing Ceramic Green Sheet

To 100 parts by weight of glass-ceramic raw material powder containing SiO₂, Al₂O₃, CaO, MgO, BaO, and B₂O₃ were added 11 parts by weight of acrylic binder (copolymer of methyl methacrylate and isobutyl methacrylate in a molar ratio of 6/4, glass transition temperature: 80° C.) and 5 parts by weight of plasticizer dibutyl phthalate. The materials were mixed with toluene as an organic solvent in a ball mill for 36 hours to prepare a slurry. The resulting slurry was formed into a 20 μm thick ceramic green sheet by a doctor blade method and subsequent drying. The ceramic green sheet was punched to form a through hole of 60 μm diameter therein.

Subsequently, the through hole of the ceramic green sheet was filled with the following third paste composition by screen printing (Samples 31 to 47 in Table 2). The proportions of the binder components shown in Table 2 are on a molar basis.

Then, the following fourth paste composition was applied to form a fine pattern (desired line width: 60 μm, desired thickness: 16 μm) by screen printing. The pattern of the fourth paste composition was dried in a hot air drying oven at 80° C. for 1 hour, thus forming metalized conductive layers. Then the printed pattern was pressed at a pressure of 4.9 MPa to be planarized while being heated at the planarizing temperature shown in Table 2.

### 2. Preparing Paste Composition

### 2-1 Third Paste Composition (for Forming Via Conductor)

To 100 parts by weight of Cu powder were added 2 parts by weight of the silica-containing glass raw material powder used above for the ceramic green sheet, 2 parts by weight of the binder shown in Samples 31 to 47 in Table 2, 4 parts by weight of a mixed solvent of terpineol and butyl Carbitol acetate, and 2 parts by weight of dibutyl phthalate, and the materials were stirred to mix. Subsequently, the mixture was further mixed in a three roll mill until the aggregate of the Cu powder and binder disappeared. Thus, the third paste composition was prepared.

In the column of the binder component shown in Table 2, MMA represents methyl methacrylate; BMA, butyl methacrylate; IBMA, isobutyl methacrylate; EMA, ethyl methacrylate; MPEGMA, methoxypolyethylene glycol monomethacrylate; PEGMA, polyethylene glycol monomethacrylate; 2HEMA, 2-hydroxyethyl methacrylate; DMAEMA, dimethylaminoethyl methacrylate; MAA, methacrylic acid; 2EHMA, 2-ethylhexyl methacrylate; and 2EHA, 2-ethylhexyl acrylate.

The glass transition temperature Tg of each copolymer binder shown in Table 2 was calculated from the Fox equation: 1/Tg=w1/Tg1+w2/Tg2 (where w1 and Tg1 and w2 and Tg2 represent the weight fractions and the glass transition temperatures of each homopolymer, respectively).

### 2-2 Fourth Paste Composition (for the Conductive Layers

To 100 parts by weight of Cu powder were added 5 parts by weight of the silica-containing glass raw material powder used above for the ceramic green sheet, 0.1 part by weight of silica fine particles (mean primary particle size: 15 nm), 6 parts by weight of the binder shown in Samples 31 to 47 in Table 2 (the same as the binder of the via conductor), 10 parts by weight of a mixed solvent of terpineol and butyl Carbitol acetate, and 2 parts by weight of dibutyl phthalate, and the materials were stirred to mix. Subsequently, the mixture was further mixed in a three roll mill until the aggregate of the Cu powder and binder disappeared. Thus, the fourth paste composition was prepared.

### 3. Preparing Multilayer Ceramic Circuit Board

Three ceramic green sheets prepared as in 1. above, to which an adhesive containing an acrylic resin, a solvent, and a phthalic ester plasticizer has been applied, were stacked and pressed at a pressure of 4.9 MPa to be integrated together. Thus, a ceramic green sheet stack including fine conductive layers inside was prepared. Then, the stack was placed on an Al₂O₃ setter and subjected to the removal of the binder in an atmosphere of a nitrogen-hydrogen-water vapor mixture in a furnace using a predetermined temperature profile, followed by firing at a maximum temperature of 950 to 1000° C.

### COMPARISON EXAMPLE 2

Multilayer ceramic circuit boards (comparative Samples 31 to 43) were prepared in the same manner as those of Samples 31 to 47 except that the binders of Comparative Samples 31 to 43 shown in Table 2 were used as the binder of the third and the fourth paste composition.

### Spinnability of the Third and the Fourth Paste Compositions

The binder components of the third and the fourth paste composition used in Samples 31 to 47 and Comparative Samples 31 to 43 are shown in Table 2. Table 2 also shows the results of the following measurements, the visual evaluation results (◯: good, Δ: fair, or x: poor) of the spinnability (snap-off characteristics from a printing screen) of the third and the fourth paste as a screen printing characteristic.

### Line Width of the Conductive Layer

The conductive layers were formed of the fourth paste composition on a ceramic green sheet by printing and planarizing (before firing). The line width and thickness of the conductive layers (formed to a desired line width of 60 μm and a desired thickness of 16 μm, and then planarized to a desired width of 80 μm) were measured at 10 points for each sample with an ultra-deep profile measuring microscope (VK8510, manufactured by Keyence Corporation) and averaged. After firing the multilayer ceramic circuit board, a section of the multilayer ceramic circuit board was examined to determine whether or not a delamination occurred around the internal conductive layers. In Table 2, the sample in which the line width in the conductive layers was within ±10% from the desired value, was evaluated as ◯ (good). The sample in which the line width was within ±25% from the desired value, however, the line width was not within 10%, was evaluated as Δ (fair). The sample in which the line width was not within ±25% from the desired value, was evaluated as x (poor).

Measuring Binder Residue after Thermal Decomposition

The binder (or binder mixture for ceramic sintering, if at least two types of binder were used) was subjected to thermogravimetry/differential thermal analysis (TG/DTA) in a N₂ atmosphere at a heating rate of 10° C./minute up to 500° C. with a high-temperature differential thermobalance (TG8120, manufactured by Rigaku Corporation), and the rate of thermal decomposition residue at 500° C. was calculated from the equation: 100×(residue weight at 500° C.)/(sample weight before analysis).

### Measuring Rheological Characteristics of Third and the Fourth Paste Composition

The viscosity was measured at 0.1 s⁻¹ and 100 s⁻¹ by a cone-plate method (using a 1 degree cone of 25 mm in diameter, 25° C.) with a rheometer MCR301 manufactured by Physica. The TI value (thixotropy index, ratio of viscosity at 0.1 s⁻¹ to viscosity at 100 s⁻¹) was also calculated. The measurement was performed twice, immediately after the preparation of the third and the fourth paste composition and after a week, and the change in viscosity after a week was calculated from the equation: 100×{(viscosity after a week)−(viscosity immediately after preparation)}/(viscosity immediately after preparation).

Hereinafter, the rate of viscosity change after a week at viscosity of 1 s⁻¹ is referred to “RVC3” and the rate of viscosity change after a week at viscosity of 100 s⁻¹ is referred to “RVC4”.

In Table 2, the sample in which both of RVC3 and RVC4 were not less than −30% and not more than 30%, was evaluated as ◯ (good). The sample in which both of RVC3 and RVC4 were not less than −40% and not more than 40%, however, at least one of RVC3 and RVC4 was not less than 30% or not more than −30%, was evaluated as Δ (fair). The sample in which at least one of RVC3 and RVC4 was not less than 40% or not more than −40%, was evaluated as x (poor).

### Total Evaluation

In the total evaluation of the Table 2, [symbol] (excellent) indicates all of “Rate of viscosity change after 1 week”, “Spinnability” and “Line width” were good. ◯ (good) indicates all of “Rate of viscosity change after 1 week”, “Spinnability” and “Line width” were at least fair although not all of them are good. x (poor) indicates at least one of “Rate of viscosity change after 1 week”, “Spinnability” and “Line width” was poor.

TABLE 2

| | | | | | | | | Rheological characteristics | | |
|---|---|---|---|---|---|---|---|---|---|---|
| | Binder | | | | | | | of third and the fourth | | |
| | | | | | | | 500° C. | paste compositions | | |
| | | Molecular | Glass transition | | | | Residue | Viscosity | | Tl value |
| | Binder component | weight | temperature (° C.)* | | | | ratio | (Pa · s) | | (η0.1s⁻¹ / |
| | (numbers represent proportions) | (×10⁴) | Tg[h] | Tg[l] | ΔTg | Tg | (wt %) | η0.1s⁻¹ | η100s⁻¹ | η100s⁻¹) |
| Sample 31 | MMA-co-BMA-co-MPEGMA = 47/47/6 | 2.1 | 105 | 20 | 85 | 55 | 0.6 | 115 | 31 | 3.7 |
| Sample 32 | MMA-co-BMA-co-PEGMA = 47/47/6 | 2.2 | 105 | 20 | 85 | 48 | 0.6 | 126 | 52 | 2.4 |
| Sample 33 | MMA-co-BMA-co-2HEMA = 47/47/6 | 3.2 | 105 | 20 | 85 | 57 | 0.5 | 208 | 97 | 2.1 |
| Sample 34 | MMA-co-BMA-co-MPEGMA = 47/47/6 | 9.3 | 105 | 20 | 85 | 55 | 0.3 | 127 | 41 | 3.1 |
| Sample 35 | MMA-co-BMA-co-PEGMA = 47/47/6 | 8.9 | 105 | 20 | 85 | 48 | 0.5 | 139 | 64 | 2.2 |
| Sample 36 | MMA-co-BMA-co-2HEMA = 47/47/6 | 9.2 | 105 | 20 | 85 | 57 | 0.3 | 234 | 116 | 2.0 |
| Sample 37 | MMA-co-IBMA-co-MPEGMA = 47/47/6 | 8.8 | 105 | 48 | 57 | 71 | 0.6 | 118 | 42 | 2.8 |
| Sample 38 | MMA-co-IBMA-co-PEGMA = 47/47/6 | 9.4 | 105 | 48 | 57 | 63 | 0.4 | 133 | 62 | 2.1 |
| Sample 39 | MMA-co-IBMA-co-2HEMA = 47/47/6 | 8.9 | 105 | 48 | 57 | 73 | 0.6 | 223 | 107 | 2.1 |
| Sample 40 | MMA-co-BMA-co-2HEMA = 40/40/20 | 9.3 | 105 | 20 | 85 | 56 | 0.7 | 256 | 127 | 2.0 |
| Sample 41 | MMA-co-BMA-co-2HEMA = 67/28/5 | 4.8 | 105 | 20 | 85 | 74 | 0.3 | 271 | 134 | 2.0 |
| Sample 42 | MMA-co-BMA-co-2HEMA = 24/56/20 | 5.7 | 105 | 20 | 85 | 43 | 0.5 | 203 | 89 | 2.3 |
| Sample 43 | MMA-co-BMA = 50/50 | 9.3 | 105 | 20 | 85 | 57 | 0.2 | 101 | 54 | 1.9 |
| Sample 44 | MMA-co-IBMA = 50/50 | 9.6 | 105 | 48 | 57 | 74 | 0.5 | 102 | 61 | 1.7 |
| Sample 45 | MMA-co-BMA-co-2HEMA = 47/47/6 | 13 | 105 | 20 | 85 | 57 | 0.6 | 298 | 135 | 2.2 |
| Sample 46 | MMA-co-BMA-co-DMAEMA = 49/49/2 | 3.9 | 105 | 20 | 85 | 56 | 0.6 | 203 | 132 | 1.5 |
| Sample 47 | MMA-co-BMA-co-MAA = 49/49/2 | 4.8 | 105 | 20 | 85 | 59 | 0.8 | 311 | 172 | 1.8 |
| | Random copolymer | | | | | | | | | |
| Comparative | MMA-co-EMA = 50/50 | 8.9 | 105 | 65 | 40 | 84 | 0.3 | X Paste solidified | | |
| Sample 31 | | | | | | | | (measurement and | | |
| | | | | | | | | printing impossible) | | |
| Comparative | IBMA-co-2EHMA = 50/50 | 9.2 | 48 | −10 | 58 | 16 | 0.4 | 71 | 53 | 1.3 |
| Sample 32 | | | | | | | | | | |
| Comparative | EMA-co-BMA = 50/50 | 9.6 | 65 | 20 | 45 | 49 | 0.4 | 76 | 56 | 1.4 |
| Sample 33 | | | | | | | | | | |
| Comparative | BMA-co-2EHA = 50/50 | 9.1 | 20 | −68 | 88 | −32 | 1.0 | 44 | 37 | 1.2 |
| Sample 34 | | | | | | | | | | |
| Comparative | IBMA-co-BMA = 50/50 | 9.6 | 48 | 20 | 28 | 33 | 0.1 | 88 | 65 | 1.4 |
| Sample 35 | | | | | | | | | | |
| Comparative | IBMA-co-BMA-co-2HEMA = 47/47/6 | 9.2 | 48 | 20 | 28 | 34 | 0.3 | 106 | 59 | 1.8 |
| Sample 36 | | | | | | | | | | |
| Comparative | MMA-co-EMA-co-2HEMA = 47/47/6 | 2.6 | 105 | 65 | 40 | 82 | 0.8 | 327 | 156 | 2.1 |
| Sample 37 | | | | | | | | | | |
| Comparative | MMA-co-BMA-co-2HEMA = 35/35/30 | 8.7 | — | — | — | 55 | 0.9 | X Paste solidified | | |
| Sample 38 | | | | | | | | (measurement and | | |
| | | | | | | | | printing impossible) | | |
| Comparative | MMA-co-BMA-co-MPEGMA = 47/47/6 | 9.3 | 105 | 20 | 85 | 55 | 0.3 | 127 | 41 | 3.1 |
| Sample 39 | | | | | | | | | | |
| Comparative | MMA-co-BMA-co-MPEGMA = 47/47/6 | 9.3 | 105 | 20 | 85 | 55 | 0.3 | 127 | 41 | 3.1 |
| Sample 40 | | | | | | | | | | |
| | Homopolymer mixture | | | | | | | | | |
| Comparative | MMA + BMA = 50/50 | 7 + 8 | 105 | 20 | 85 | — | 0.2 | 135 | 39 | 3.5 |
| Sample 41 | | | | | | | | | | |
| Comparative | MMA + IBMA = 50/50 | 7 + 9 | 105 | 48 | 57 | — | 0.2 | 112 | 48 | 2.3 |
| Sample 42 | | | | | | | | | | |
| | Homopolymer + hydrogenated | | | | | | | | | |
| | castor oil thickener | | | | | | | | | |
| Comparative | BMA + thickener = 95/5 | 5.2 | — | 20 | — | 20 | 0.2 | 191 | 81 | 2.4 |
| Sample 43 | | | | | | | | | | |

| | Rheological characteristics | | | | | | | | | | |
|---|---|---|---|---|---|---|---|---|---|---|---|
| | of third and the fourth | | | | | | | | | | |
| | paste compositions | | | | | | | | | | |
| | Rate of viscosity | | | | Planarizing | | | | Thickness | | |
| | change after 1 week | | | | temperature | | conductive layer | | ratio t/T | | |
| | (%) | | | | Set | | dimensions (μm) | | (Green | | |
| | | | Evalu- | Spinna- | value | Set value − | Line | Thickness | sheet: | | Total |
| | η0.1S⁻¹ | η100S⁻¹ | ation | bility | (° C.) | Tg (° C.) | width | t | T = 20) | Delamination | evaluation |
| Sample 31 | −11 | −14 | ◯ | ◯ | 85 | 30 | 86 (◯) | 11.3 | 0.57 | No | ⊚ |
| Sample 32 | −16 | 17 | ◯ | ◯ | 80 | 32 | 84 (◯) | 11.5 | 0.58 | No | ⊚ |
| Sample 33 | 11 | 13 | ◯ | ◯ | 85 | 28 | 82 (◯) | 11.9 | 0.60 | No | ⊚ |
| Sample 34 | −22 | −8 | ◯ | ◯ | 90 | 35 | 80 (◯) | 11.8 | 0.59 | No | ⊚ |
| Sample 35 | −18 | 13 | ◯ | ◯ | 80 | 32 | 78 (◯) | 12.3 | 0.62 | No | ⊚ |
| Sample 36 | 14 | 10 | ◯ | ◯ | 90 | 33 | 79 (◯) | 12.7 | 0.64 | No | ⊚ |
| Sample 37 | −21 | −17 | ◯ | ◯ | 100 | 29 | 81 (◯) | 12.9 | 0.65 | No | ⊚ |
| Sample 38 | −17 | −13 | ◯ | ◯ | 95 | 32 | 80 (◯) | 12.8 | 0.64 | No | ⊚ |
| Sample 39 | −12 | −8 | ◯ | ◯ | 100 | 27 | 78 (◯) | 13.1 | 0.66 | No | ⊚ |
| Sample 40 | 23 | 18 | ◯ | ◯ | 85 | 29 | 77 (◯) | 12.7 | 0.64 | No | ⊚ |
| Sample 41 | −8 | −10 | ◯ | ◯ | 100 | 26 | 76 (◯) | 13.4 | 0.67 | No | ⊚ |
| Sample 42 | 13 | 17 | ◯ | ◯ | 70 | 27 | 80 (◯) | 11.6 | 0.58 | No | ⊚ |
| Sample 43 | 21 | 18 | ◯ | Δ | 85 | 28 | 94 (□) | 10.3 | 0.52 | No | ◯ |
| Sample 44 | −32 | −20 | □ | Δ | 100 | 26 | 98 (□) | 9.9 | 0.50 | No | ◯ |
| Sample 45 | −14 | −11 | ◯ | Δ | 90 | 33 | 77 (◯) | 12.5 | 0.63 | No | ◯ |
| Sample 46 | −31 | −33 | □ | Δ | 85 | 29 | 78 (◯) | 11.9 | 0.60 | No | ◯ |
| Sample 47 | 33 | 29 | □ | Δ | 90 | 31 | 76 (◯) | 13.1 | 0.66 | No | ◯ |
| Comparative | — | — | | — | — | — | — | — | — | — | X |
| Sample 31 | | | | | | | | | | | |
| Comparative | −11 | −25 | ◯ | Δ | 45 | 29 | 121 (X) | 7.8 | 0.39 | No | X |
| Sample 32 | | | | | | | | | | | |
| Comparative | −16 | −22 | ◯ | Δ | 80 | 31 | 116 (X) | 9.0 | 0.45 | No | X |
| Sample 33 | | | | | | | | | | | |
| Comparative | −21 | −26 | ◯ | X | 20 | 52 | 134 (X) | 7.5 | 0.38 | No | X |
| Sample 34 | | | | | | | | | | | |
| Comparative | −8 | 11 | ◯ | Δ | 65 | 32 | 103 (X) | 9.1 | 0.46 | No | X |
| Sample 35 | | | | | | | | | | | |
| Comparative | 18 | 28 | ◯ | X | 65 | 31 | 95 (□) | 10.6 | 0.53 | No | X |
| Sample 36 | | | | | | | | | | | |
| Comparative | 31 | 42 | X | X | 110 | 28 | 76 (◯) | 12.4 | 0.62 | No | X |
| Sample 37 | | | | | | | | | | | |
| Comparative | — | — | | — | — | — | — | — | — | — | X |
| Sample 38 | | | | | | | | | | | |
| Comparative | −22 | −8 | ◯ | ◯ | 95 | 40 | 109 (X) | 9.2 | 0.46 | No | X |
| Sample 39 | | | | | | | | | | | |
| Comparative | −22 | −8 | ◯ | ◯ | 75 | 20 | 71 (◯) | 14.6 | 0.73 | Yes | X |
| Sample 40 | | | | | | | | | | | |
| Comparative | 32 | 46 | X | Δ | 85 | — | 75 (◯) | 14.3 | 0.72 | Yes | X |
| Sample 41 | | | | | | | | | | | |
| Comparative | 38 | 48 | X | Δ | 100 | — | 73 (◯) | 14.5 | 0.73 | Yes | X |
| Sample 42 | | | | | | | | | | | |
| Comparative | 47 | 36 | X | ◯ | 50 | 30 | 81 (◯) | 12.7 | 0.64 | No | X |
| Sample 43 | | | | | | | | | | | |

*Glass transition temperatures of ternary binders are represented by Tg[h] for H component and Tg[l] for L component, satisfying (Hm + Lm)/Pm ≧ 0.8.
□: excellent.
◯: good,
□: fair,
X: poor

As shown in Table 2, Samples 31 to 47 using the third and the fourth paste compositions prepared according to the present invention exhibited superior rheological characteristics and suitably low spinnability. Also, the third and the fourth paste compositions of Samples 31 to 47 had superior printing characteristics and formed favorable printed patterns as desired. In addition, the third and the fourth paste compositions of Samples 31 to 47 had suitable long-term viscosity stability and were, accordingly, able to be stored for a long time. In particular, the binder compositions of samples 31 to 42, which contain a (meth)acrylic ester copolymer to which a (meth)acrylic ester having polar functional group, selected from among (meth)acrylic esters having hydroxyl group and (meth)acrylic esters having polyalkylene oxide chain was copolymerized, exhibited superior results on the whole.

In addition, since the circuit board was pressed for planarization at a temperature appropriately set according to the transition temperature Tg of the binder, only the paste layer was able to be selectively planarized. More specifically, the thickness t of the paste layer and the thickness T of the ceramic green sheet satisfied the relationship t≦0.7T. Consequently, a multilayer circuit board including stepless conductive layers was produced.

On the other hand, Comparative Sample 31 used an H component satisfying Tg[h]≧100° C., but did not satisfy ΔTg≧50° C. Consequently, the third and the fourth pastes exhibited low fluidity and gelled, and accordingly they were not able to be applied by printing. Comparative samples 32 to 35 each used an H component having a glass transition temperature of Tg[h]<100° C., but used an L component selected so that ΔTg would become about 50° C. The resulting paste compositions exhibited a low viscosity and a low thixotropy, and accordingly the resulting printed patterns were, for example, spread and thus unfavorable. In Comparative Sample 34, the third and the fourth paste composition used a (meth)acrylic ester copolymer having a low Tg (−32° C.), and accordingly exhibited a high viscosity and thus a significantly worsened spinnability. The planarization of the printed pattern was performed at room temperature (20° C.) without heating. However, the paste layer was excessively deformed because the temperature of the planarization was much higher than Tg+30±5° C.

In Comparative Sample 36, 2HEMA having a polar functional group was copolymerized. Consequently, the viscosity and the thixotropy of the third and the fourth paste were improved, but the spinnability was worsened.

In Comparative Sample 37, the molecular weight of the binder was reduced and 2HEMA having a polar functional group was introduced while an H component having a glass transition temperature satisfying Tg[h]≧100° C. was used. However, the resulting paste exhibited a high elasticity and poor spinnability during screen printing, due to ΔTg<50° C. In addition, the viscosity of the third and the fourth paste was increased to some extent over a week. Furthermore, since the paste layer was planarized at a temperature of 110° C., which is 30° C. higher than the Tg (80° C.) of the binder used in the ceramic green sheet, the ceramic green sheet was partially extended to some extent by the planarization and, thus, the dimensional accuracy was degraded.

In Comparative Sample 38, the content of the methacrylate having hydroxyl group was increased. However, the viscosity was gradually increased from a time immediately after the preparation of the third and the fourth paste compositions, and these compositions finally gelled after several days to the extent that they were not able to be applied by printing. The results above suggest that the binder containing (meth)acrylic ester copolymer P containing an H component and an L component in proportions of (Hm+Lm)/Pm<0.8, that is, copolymer P to which more than 20 mol % of (meth)acrylic ester having polar functional group is copolymerized, causes excessive intermolecular interaction.

In Comparative Samples 39 and 40, a conductive layer was printed with the same paste composition as in Sample 34, and was planarized under the same conditions as in Sample 34 except the temperature. In Comparative Sample 39, the planarization was performed at a temperature higher than Tg+30±5° C., and consequently the paste layer was excessively deformed. In contrast, Comparative Sample 40 performed the planarization at a temperature lower than Tg+30±5° C., and the paste layer was not sufficiently plastic-deformed. Consequently, the thickness t of the paste layer became t>0.7T, where T represents the thickness of the ceramic green sheet in contact with the paste layer. Thus, gaps resulting from differences in thickness among the internal conductive layers were not able to be eliminated only by plastic deformation of the ceramic green sheets when they were stacked. Consequently, delamination occurred in the product after firing.

Comparative Samples 41 and 42 each used a mixture of homopolymers having the same compositions and the same molecular weight as the homopolymers used for the copolymer of Samples 43 or 44. However, the resulting paste of each comparative sample exhibited a low long-term viscosity stability, the viscosity increased over time.

In Comparative Sample 43, a hydrogenated castor oil thickener was added to a BMA homopolymer. The resulting paste composition exhibited suitable rheological characteristics immediately after being prepared. However, the long-term viscosity stability was poor, and the viscosity was seriously increased after a week.

By appropriately adjusting the composition of the binder used to make the paste, a manufacturer of a ceramic article can carefully control the rheologic properties of the paste appropriately for its intended use.

An important parameter to manipulate in the binder composition is the glass transition temperature of the binder and the difference in the glass transition temperature of the components H and L in copolymer P. Also, in the case where the inorganic particle of the paste includes a silica particle, the size of the silica particle and amount thereof can be adjusted.

What is claimed is:

1. A paste composition comprising:
inorganic particles; and
a binder containing a copolymer made by copolymerizing a mixture, wherein
the mixture comprises
a first (meth)acrylic ester whose homopolymer has a first glass transition temperature Tg[h]; and
a second (meth)acrylic ester whose homopolymer has a second glass transition temperature Tg[l] lower than the first glass transition temperature Tg[h],
wherein the total molar fraction of the first and second (meth) acrylic esters in the mixture is 80 mol % or more, and
wherein the first and the second glass transition temperatures Tg[h] and Tg[L] satisfy the relationships Tg[h]≧100° C. and Tg[h]−Tg[l]≧50° C.

2. The paste composition according to claim 1, wherein the mixture further comprises a third (meth)acrylic ester having at least one polar functionality, selected from the group consisting of (meth)acrylic ester having hydroxyl group and (meth)acrylic ester having polyalkylene oxide chain.

3. The paste composition according to claim 1, wherein the binder has a weight-average molecular weight in the range of 20,000 to 100,000.

4. The paste composition according to claim 1, further comprising 0.1 to 10 parts by weight of nitrocellulose to 100 parts by weight of the binder.

5. The paste composition according to claim 1, wherein 99 percent by weight of the binder is thermally decomposed in a nitrogen atmosphere at 500° C.

6. The paste composition according to claim 1, wherein the inorganic particles comprises glass particles containing silica.

7. The paste composition according to claim 1, wherein the inorganic particles comprises electroconductive material.

8. The paste composition according to claim 1, wherein the inorganic particles comprises dielectric material.

9. The paste composition according to claim 1, wherein the first and the second glass transition temperatures Tg[h] and Tg[L] satisfy the relationship Tg[h]−Tg[l]≦250° C.

10. A green ceramic body comprising:
a green ceramic base; and
a paste composition applied to the green ceramic base, the paste composition including inorganic particles, and a binder containing a copolymer made by copolymerizing a mixture, wherein the mixture comprises
a first (meth)acrylic ester whose homopolymer has a first glass transition temperature Tg[h], and
a second (meth)acrylic ester whose homopolymer has a second glass transition temperature Tg[l] lower than the first glass transition temperature Tg[h],
wherein the total molar fraction of the first and the second (meth)acrylic esters in the mixture is 80 mol % or more, and
wherein the first and the second glass transition temperatures Tg[h] and Tg[L] satisfy the relationships Tg[h]≧100° C. and Tg[h]−Tg[l]≧50.

11. The green ceramic body according to claim 10, wherein the inorganic particles of the paste composition contains glass particles, and the green ceramic base contains glass particles having the same composition as the glass particles of the paste composition at least in the portion to which the paste composition is applied.

12. A method for manufacturing a ceramic structure comprising:
preparing a paste composition containing inorganic particles and a binder containing a copolymer made by copolymerizing a mixture comprising a first (meth)acrylic ester whose homopolymer has a first glass transition temperature Tg[h] and a second (meth)acrylic ester whose homopolymer has a second glass transition temperature Tg[l], wherein the total molar fraction of the first and the second (meth)acrylic esters in the mixture is 80 mol % or more and the first and the second glass transition temperatures Tg[h] and Tg[L] satisfy the relationships Tg[h]≧100° C. and Tg[h]−Tg[l]≧50° C.;
forming a green ceramic body by applying the paste composition to a green ceramic base by printing; and
firing the green ceramic body.

13. A method for manufacturing a ceramic structure comprising:
applying a paste composition containing inorganic particles and a binder containing a copolymer made by copolymerizing a mixture comprising a first (meth)acrylic ester whose homopolymer has a first glass transition temperature Tg[h], and a second (meth)acrylic ester whose homopolymer has a second glass transition temperature Tg[l], wherein the total molar fraction of the first and the second (meth)acrylic esters in the mixture is 80 mol % or more and the first and the second glass transition temperatures Tg[h] and Tg[L] satisfy the relationships Tg[h]≧100° C. and Tg[h]−Tg[l]≧50° C.;
to a first ceramic green sheet by printing;
planarizing the surface of the paste layer by pressing the paste layer at a temperature 30±5° C. higher than the glass transition temperature of the binder so as to plastic-deform the paste layer.

14. The method according to claim 13, wherein the paste layer has a thickness t after being planarized, and the thickness t and the thickness T of the first ceramic green sheet in contact with the paste layer satisfy the relationship: t≦0.7T.

15. A paste composition comprising:
inorganic particles; and
a binder containing a copolymer comprising
a first (meth)acrylic ester unit whose homopolymer has a first glass transition temperature Tg[h]; and
a second (meth)acrylic ester unit whose homopolymer has a second glass transition temperature Tg[l] lower than the first glass transition temperature Tg[h],
wherein the total molar fraction of the first and second (meth) acrylic esters in the mixture is 80 mol % or more, and
wherein the first and the second glass transition temperatures Tg[h] and Tg[L] satisfy the relationships Tg[h]≧100° C. and Tg[h]−Tg[l]≧50° C.

16. A method for manufacturing a ceramic structure comprising:
Applying a paste composition containing inorganic particles and a binder, comprising a first (meth)acrylic ester whose homopolymer has a first glass transition temperature Tg[h] and a second (meth)acrylic ester whose homopolymer has a second glass transition temperature Tg[l], wherein the total molar fraction of the first and the second (meth)acrylic esters in the mixture is 80 mol % or more and the first and the second glass transition temperatures Tg[h] and Tg[L] satisfy the relationships Tg[h]≧100° C. and Tg[h]−Tg[l]≧5° C.;
to a green ceramic body by printing; and
firing the green ceramic body.

17. A green ceramic body comprising:
a green ceramic base having a paste composition thereon; the paste composition including inorganic particles, and a binder containing a copolymer comprising
a first (meth)acrylic ester whose homopolymer has a first glass transition temperature Tg[h], and
a second (meth)acrylic ester whose homopolymer has a second glass transition temperature Tg[l] lower than the first glass transition temperature Tg[h],
wherein the total molar fraction of the first and the second (meth)acrylic esters in the copolymer is 80 mol % or more, and
wherein the first and the second glass transition temperatures Tg[h] and Tg[L] satisfy the relationship Tg[h]≧100° C. and Tg[h]−Tg[l]≧50.

18. The method according to claim 13, further comprising stacking a second ceramic green sheet on the first ceramic green sheet with the paste layer therebetween, pressing the stack plates to form an integrated ceramic green body, and firing the integrated ceramic green body.
